(19) United States
(12) Patent Application Publication
(10) Pub. No.: US 2024/0305034 A1
(43) Pub. Date: Sep. 12, 2024

(54) ELECTRICAL CONNECTOR ASSEMBLY AND METHOD OF MAKING SAME

(71) Applicants: FOXCONN (KUNSHAN) COMPUTER CONNECTOR CO., LTD., Kunshan (CN); FOXCONN INTERCONNECT TECHNOLOGY LIMITED, Grand Cayman, KY (US)

(72) Inventors: CHUN-HSIUNG HSU, New Taipei (TW); Yi-Min Hsu, New Taipei (TW)

(21) Appl. No.: 18/594,419

(22) Filed: Mar. 4, 2024

(30) Foreign Application Priority Data
Mar. 6, 2023 (CN) 202310202726.2

(51) Int. Cl. H01R 13/514; H01R 12/71; H01R 13/6594; H01R 43/16; H01R 43/24

(52) U.S. Cl. CPC H01R 13/514; H01R 12/716; H01R 13/6594; H01R 43/16; H01R 43/24

(57) ABSTRACT

An electrical connector assembly includes: an insulative housing; a terminal module including a first terminal module and a second terminal module stacked with each other in a vertical direction; and a cable electrically connected to the terminal module; wherein the first terminal module includes a first row of terminals and a first insulating member holding the first row of terminals, the second terminal module includes a second row of terminals and a second insulating member holding the second row of terminals, each of the first row of terminals and the second row of terminals include a sideband terminal area and high-speed terminal areas located on the two sides of the sideband terminal area, the cable is mechanically and electrically connected to the high-speed terminal area, and the first row of terminals and the second row of terminals have same structure.

### BACKGROUND OF THE INVENTION

### Field of the Invention

The present invention relates generally to an electrical connector assembly and method of making same, and particularly to an electrical connector assembly suitable for transmitting high-speed signals that is used in communication infrastructure fields such as servers and switches.

### Description of Related Arts

China Patent Application Publication No. CN114976724A discloses an electrical connector assembly comprising an insulating hosing, a terminal module received in the insulating hosing, and a cable connected to the terminal module. The terminal module includes an upper terminal module and a lower terminal module arranged in the vertical direction. Each of the upper and lower terminal modules include a row of terminals and an insulator holding the corresponding row of terminals. However, the shapes of the insulator and terminals of the upper terminal module are different from those of the lower terminal module. Therefore, different stamping dies and forming dies are required for production, and the manufacturing cost is high.

An improved electrical connector assembly is desired.

### SUMMARY OF THE INVENTION

The objective of the present invention is to provide an electrical connector assembly that can share molds for terminal modules and reduce manufacturing costs.

To achieve the above object, an electrical connector assembly comprises: an insulative housing having a front mating slot and a rear receiving space; a terminal module including a first terminal module and a second terminal module stacked with each other in a vertical direction; and a cable electrically connected to the terminal module, wherein the first terminal module includes a first row of terminals arranged in a transverse direction perpendicular to the vertical direction and a first insulating member holding the first row of terminals, the second terminal module includes a second row of terminals arranged along the transverse direction and a second insulating member holding the second row of terminals, each of the first row of terminals and the second row of terminals include a sideband terminal area and high-speed terminal areas located on two sides of the sideband terminal area in the transverse direction, the cable is mechanically and electrically connected to the high-speed terminal area, the sideband terminal area includes a plurality of sideband terminals, and the first row of terminals and the second row of terminals have same structure.

A method of making an electrical connector assembly comprises the steps of: molding an insulating material on a first row of terminals to form a first terminal module; molding an insulating material on a second row of terminals to form a second terminal module, wherein each of the first row of terminals and the second row of terminals include a sideband terminal area and two high-speed terminal areas located on two sides of the sideband terminal area in a transverse direction; and connecting the cable to the high speed terminal area, wherein the first row of terminals and the second row of terminals are manufactured using same mold and by same method.

A method of making an electrical connector assembly comprises the steps of: stamping a metal strip to form a plurality of terminal groups each including a plurality of transversely arranged terminals; molding insulating material on each of the terminal groups to form a terminal module; turning one of the terminal modules over to be stacked up and down with another terminal module; and installing the stacked terminal modules into an insulative housing.

Compared to prior art, in the electrical connector assembly of the present invention, the structures of the first terminal module and the second terminal module are exactly the same, they can share the mold, which can reduce the manufacturing cost, and the structure is relatively simple.

### BRIEF DESCRIPTION OF THE DRAWING

FIG. 1 is a perspective view of an electrical connector assembly according to the present invention;

FIG. 2 is another perspective view of the electrical connector assembly of FIG. 1;

FIG. 3 is an exploded view of the electrical connector assembly of FIG. 1;

FIG. 4 is another exploded view of the electrical connector assembly of FIG. 3;

FIG. 5 is an exploded view of the electrical connector assembly of FIG. 3 without showing the insulative housing;

FIG. 6 is another exploded view of the electrical connector assembly of FIG. 3 without showing the insulative housing;

FIG. 7 is a further exploded view of the electrical connector assembly of FIG. 5;

FIG. 8 is another exploded p view of the electrical connector assembly of FIG. 7;

FIG. 9 is a perspective view of the upper terminal module of the electrical connector assembly of FIG. 5 and the cable connected thereto;

FIG. 10 is a perspective view of the lower terminal module of the electrical connector assembly of FIG. 5 and the cable connected thereto;

FIG. 11 is a perspective view of the upper terminal module of FIG. 9 and the cable connected to it without the transfer terminals

FIG. 12 is an exploded view of the upper terminal module of FIG. 11 and the cable connected to it without the transfer terminals;

FIG. 13 is a further view of the upper terminal module of FIG. 12 and the cable connected to it without the transfer terminals;

FIG. 14 a perspective view of the transfer terminal, mounting member and positioning member of the upper terminal module of FIG. 9, before they are assembled;

FIG. 15 a perspective view of the transfer terminal, mounting member and positioning member of the upper terminal module of FIG. 14, before they are assembled;

FIG. 16 is an exploded view of the transfer terminal, mounting member and positioning member of the upper terminal module of FIG. 15, before they are assembled;

FIG. 17 is a perspective view of the transfer terminals and mounting member of the lower terminal module of FIG. 10;

FIG. 18 is a cross-sectional view taken along line 18-18 of the electrical connector assembly of FIG. 1;

FIG. 19 is a cross-sectional view taken along line 19-19 of the electrical connector assembly of FIG. 1;

FIG. 20 is a cross-sectional view taken along line 20-20 of the electrical connector assembly of FIG. 1;

FIG. 21 is a cross-sectional view taken along line 20-20 of the upper terminal module of FIG. 9;

FIG. 22 is a perspective view of another embodiment of the mounting member mated with the transfer terminal and positioning member of the upper terminal module; and

FIG. 23 is a perspective view of the mounting member of FIG. 22 mounted on the transfer terminal of the upper terminal module.

### DETAILED DESCRIPTION OF THE PREFERRED EMBODIMENT

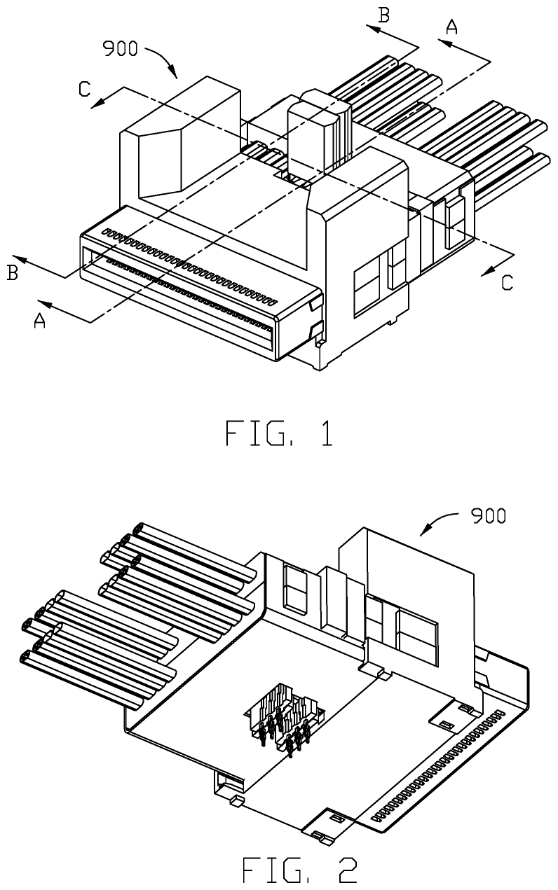

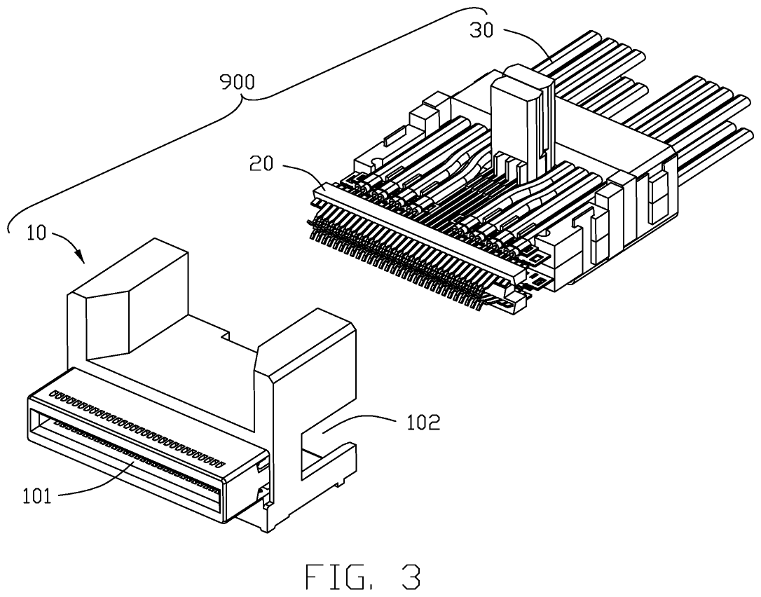

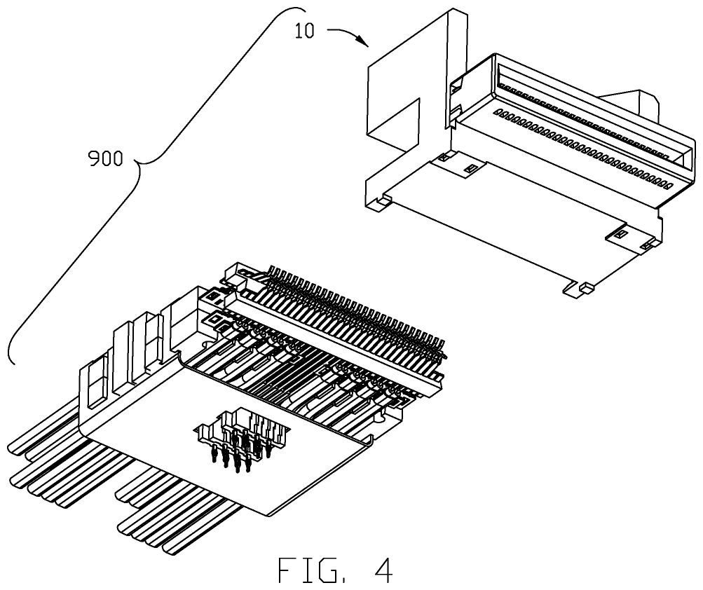

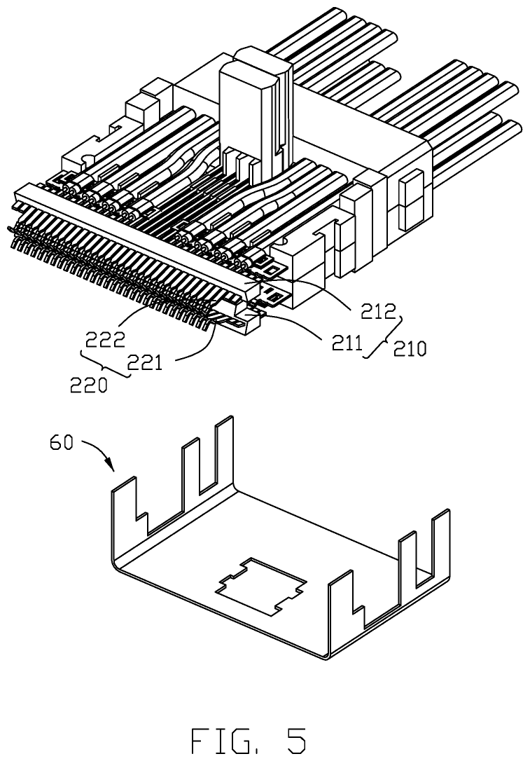

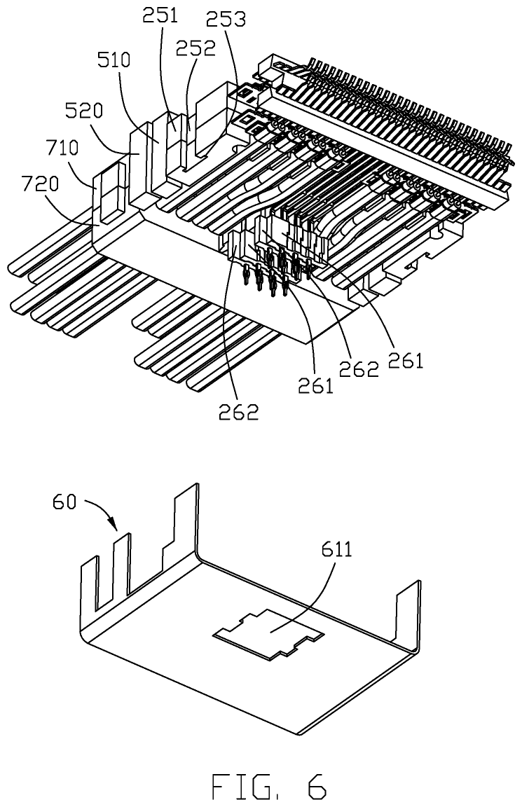

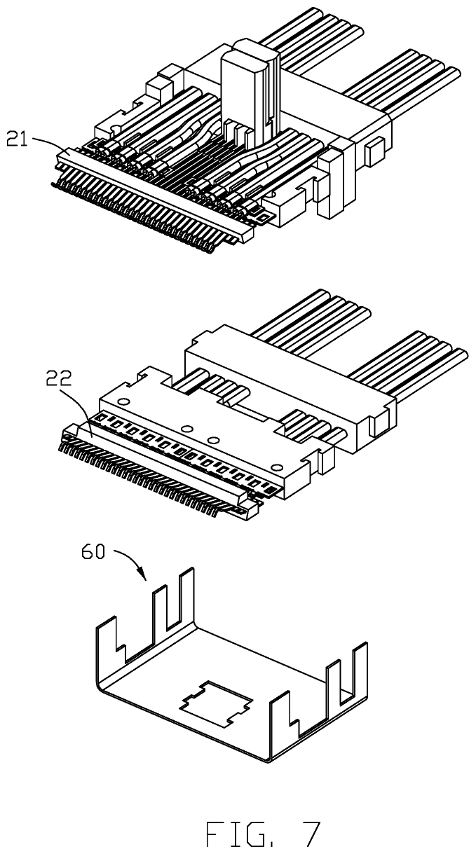

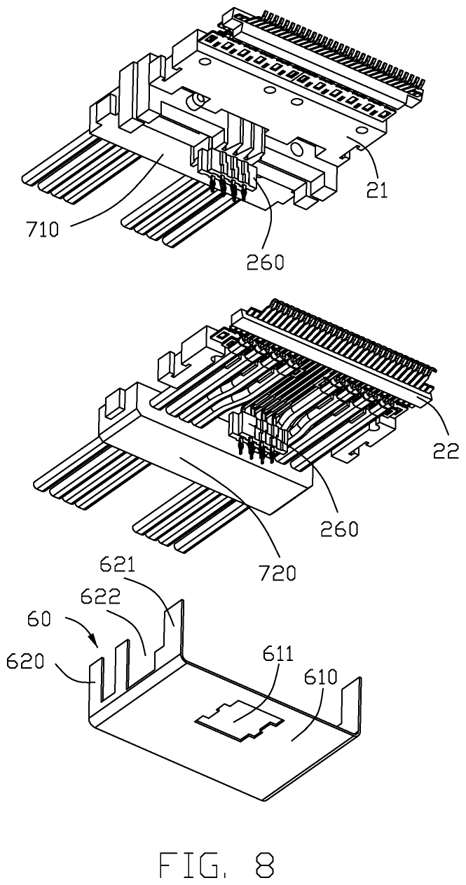

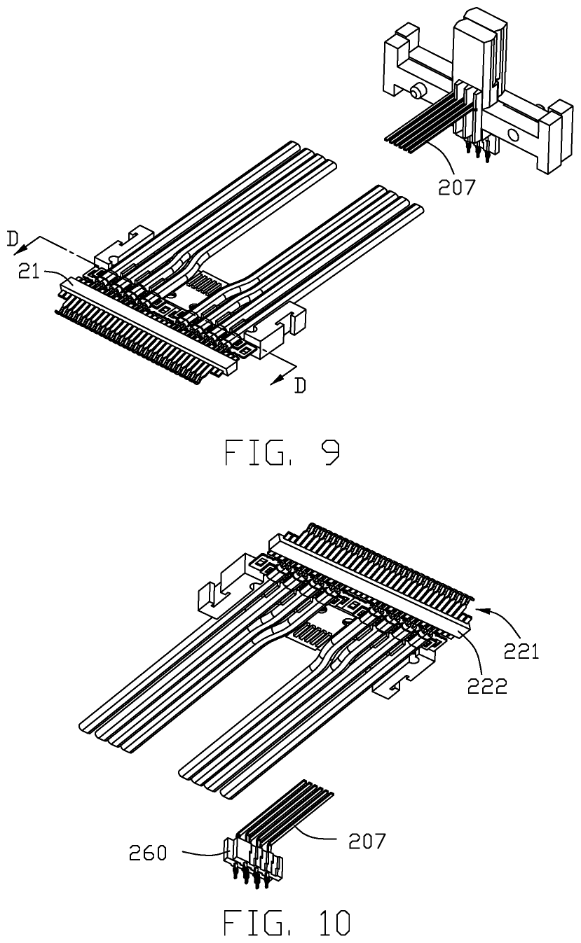

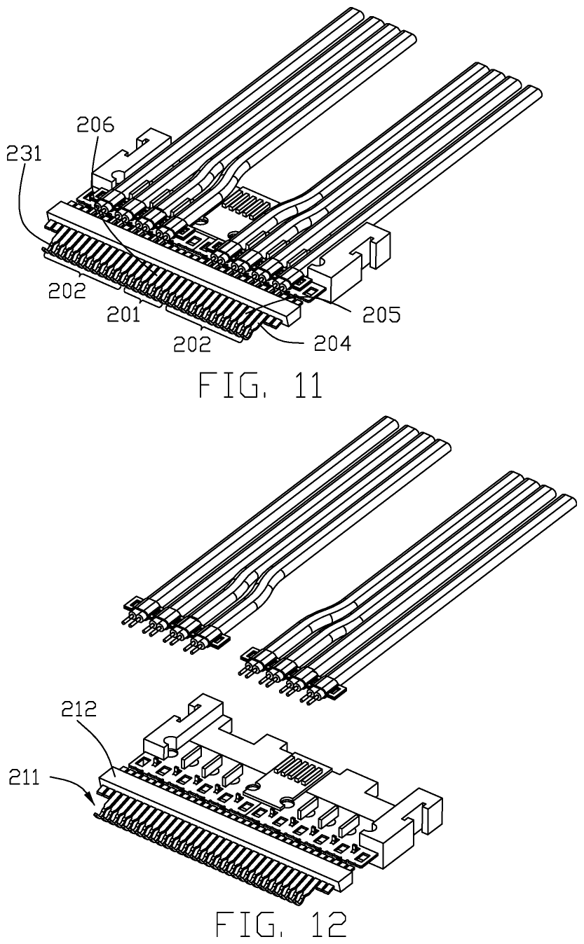

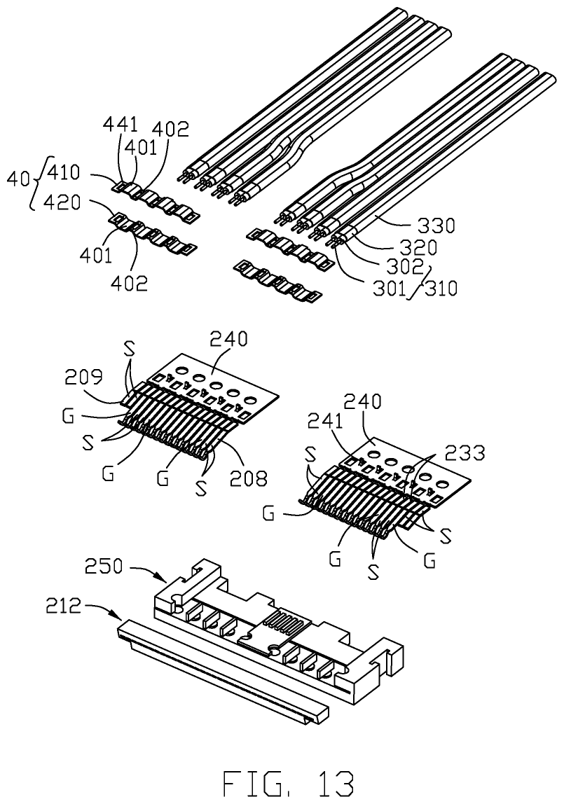

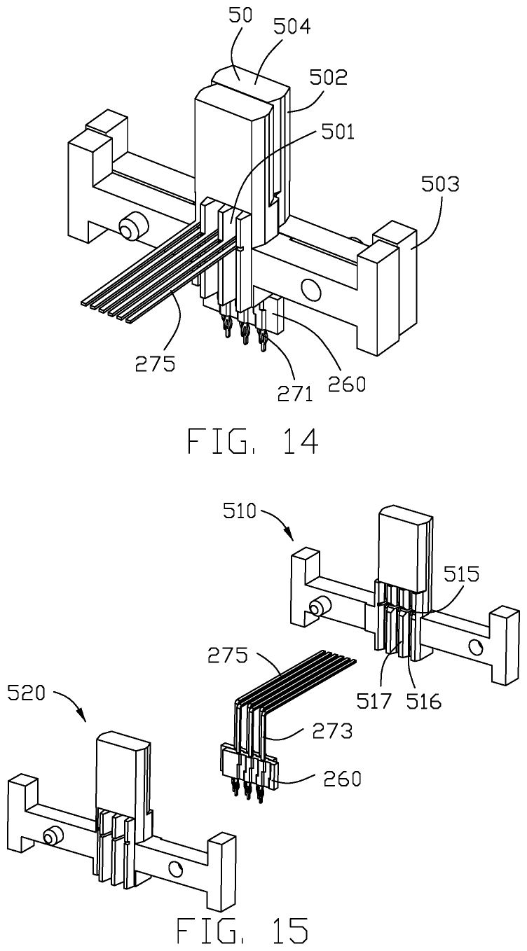

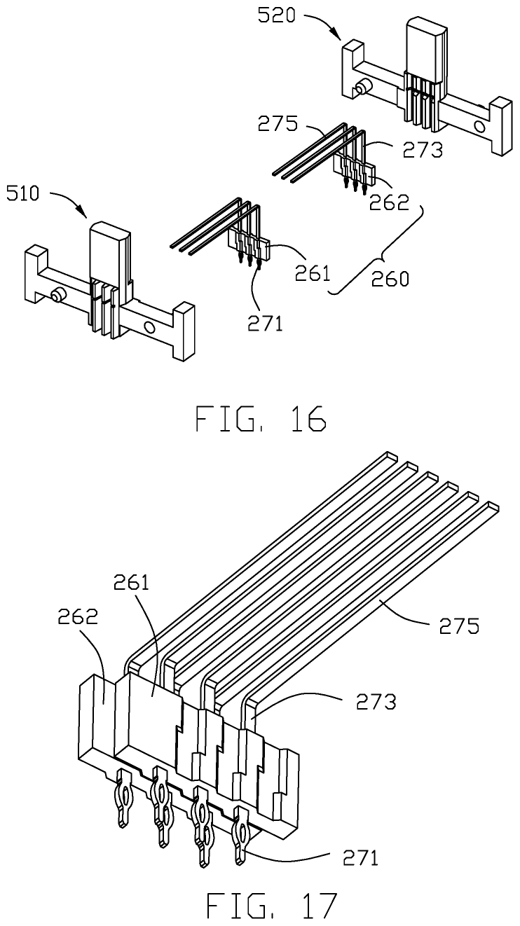

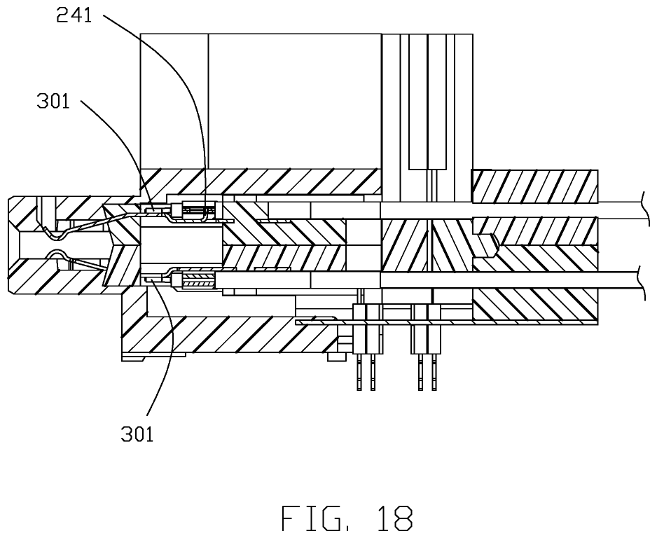

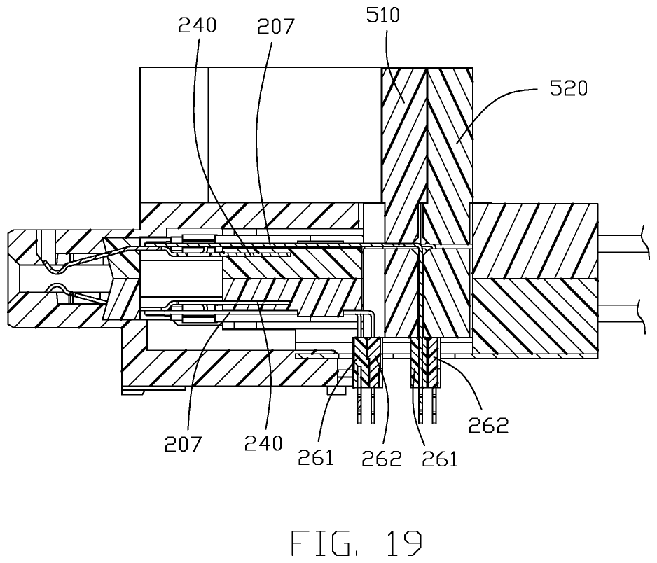

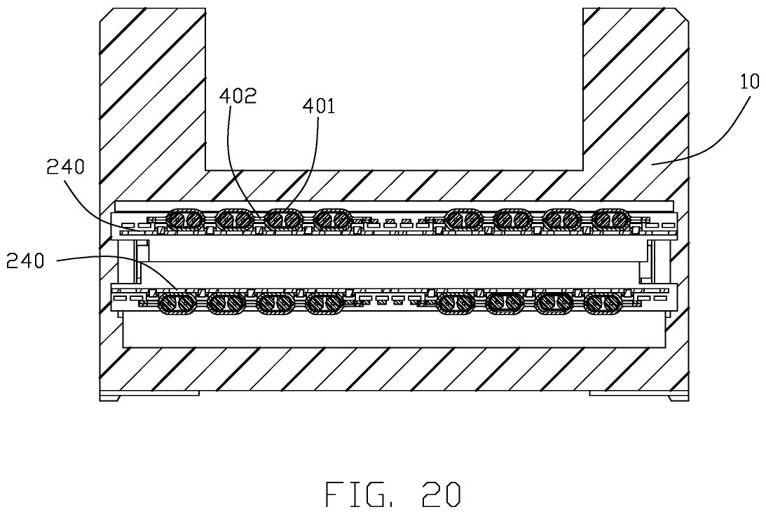

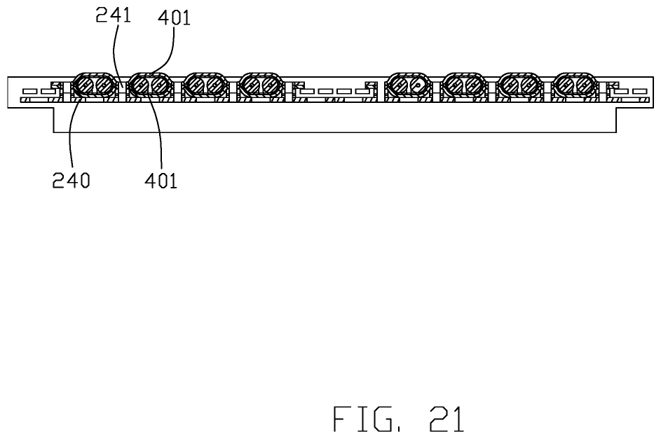

Referring to FIGS. 1-21, an electrical connector assembly 900 in accordance with the present invention is shown. The electrical connector assembly 900 can be installed on an external circuit board and can be matched with a mating connector (not shown) along a front-to-back direction

The electrical connector assembly 900 comprises an insulative housing 10, a terminal module 20 received in the insulative housing 10, and a cable 30 electrically connected to the terminal module 20 and extending backward out of the insulative housing 10. The housing 10 has a front mating slot 101 and a rear receiving space 102. The terminal module 20 includes an upper terminal module 21 and a lower terminal module 22 stacked with each other in the vertical direction. The front ends of the upper terminal module 21 and the lower terminal module 22 form a mating area for mating with the two sides of the circuit board of the mating connector.

The upper terminal module 21 includes a first terminal module 210, the lower terminal module includes a second terminal module 220. The first terminal module 210 and the second terminal module 220 are spaced apart in the vertical direction. The first terminal module 210 includes a first row of terminals 211 arranged in a transverse direction perpendicular to the vertical direction and a first insulating member 212 fixed on the first row of terminals 211. The second terminal module 220 includes a second row of terminals 221 arranged along the transverse direction and a second insulating member 222 fixed on the second row of terminals 221. The first insulating member 212 and the second insulating member 222 are integrally formed on the corresponding row of terminals. The structures of the first terminal module 210 and the second terminal module 220 are exactly the same. Specifically, the first row of terminals 211 and the second row of terminals 221 are made from the same stamping mold and have the same structure, and the first insulating member 212 and the second insulating member 222 also have the same structure, so that they can be made from the same mold.

Each of the first row of terminals 211 and the second row of terminals 221 include a high-speed terminal area 202 and a sideband terminal area 202. The sideband terminal area 201 is arranged in the middle area, and the high-speed terminal area 202 is arranged on the two sides of the sideband terminal area 201. The terminals of the high-speed terminal area 202 include ground terminals 204 and signal terminal pairs 205 arranged alternately with the ground terminals 204 in the transverse direction. Each of the high-speed terminal areas 202 has at least three pairs of signal terminals 205. Specifically, in the present invention, each of the high-speed terminal areas 202 has four pairs of signal terminal 205. The sideband terminal area 201 includes a plurality of sideband terminals 206. Each of the sideband terminals 206, the signal terminal 205 and the ground terminal 204 includes a mating portion 231 at the front for mating with the circuit board of the mating connector and a tail portion 233 at the rear. The mating portions 231 of each terminal of the first row of terminals 211 are arranged in a row in the transverse direction and are located on the upper side of the front mating slot 101. The mating portions 231 of each terminal of the second row of terminals 221 are arranged in a row along the transverse direction and are located on the lower side of the front mating slot 101.

Each of the upper terminal module 21 and the lower terminal module 22 further include a plurality of transfer terminals 207. Each of the transfer terminal 207 is mechanically and electrically connected to the corresponding sideband terminal 206. Each of the transfer terminals 207 includes a mounting foot 271 that can be mounted on the external circuit board, a vertical portion 273 extending upward from the mounting foot 271, and a horizontal portion 275 extending forward from the vertical portion 273. The mounting feet 271 are fish-eye-shaped and can be directly pressed on the external circuit board. The sideband terminals 206 of the first row of terminals 211 and the corresponding transfer terminals 207 together form the upper circuit board mounting terminals of the upper terminal module 21. Similarly, the transfer terminal 207 and the corresponding sideband terminal 206 of the second row of terminals 221 together form the lower circuit board mounting terminal of the lower terminal module 22. The front end of the horizontal portion 275 of each transfer terminal 207 is soldered to the tail portion 233 of the corresponding sideband terminal 206. In the present invention, each of the circuit board mounting terminals is divided into two sections, that is, the mating portion mated with the mating connector is provided on the sideband terminal 206, and the mounting foot 271 is provided on the transfer terminal 207.

The terminal module 20 further includes positioning members 260 respectively provided on the corresponding transfer terminals 207. The horizontal portions 275 of the upper circuit board mounting terminals are arranged in one row along the transverse direction, and the vertical portions 273 are arranged in two rows at the front and rear. The positioning member 260 is provided on the vertical portion 273. The positioning member 260 include a front positioning member 261 provided on the front row vertical part 273 and a rear positioning member 262 on the rear row vertical part. The front positioning member 261 is integrally formed on the vertical portion 273 of the front row. The rear positioning member 262 is integrally formed on the vertical portion 273 of the rear row. The front and rear positioning members are assembled and matched together. Similarly, the horizontal portions 275 of the lower circuit board mounting terminals are arranged in one row along the transverse direction, and the vertical portions 273 are arranged in two rows at the front and rear. The vertical parts of the front row and the rear row are also respectively provided with front positioning parts 261 and rear positioning parts 262. The difference is that the dimensions of the horizontal portion 275 and the vertical portion 273 of the upper circuit board mounting terminal are both larger than that of the lower circuit board mounting terminal. In the present invention, the transfer terminals 207 and the positioning members 260 of the upper and lower circuit board mounting terminals have the same structure. Therefore, both stamping dies and forming dies can be shared. After stamping the transfer terminal 207, bend it according to the required length and height.

Each of the upper terminal module 21 and the lower terminal module 22 further include a connecting portion 240 provided on the rear side of the tail portion and a rear insulator 250 integrally formed on the connecting portion 240. The connecting portion 240 is mechanically and electrically connected to the corresponding ground terminal 204 of the high-speed terminal area 202. The connecting portion 240 is a strip connecting portion when stamping terminals from a metal strip, or the connecting portion 240 is a strip that is not removed when stamping the terminals. The connecting portion 240 is connected to at least three ground terminals 204. Specifically, in the present invention, all the ground terminals 204 in the corresponding high-speed terminal area 202 are mechanically and electrically connected to the connecting portion 240.

Based on the same structure of the first row of terminals 211 and the second row of terminals 221, only the first row of terminals 211 is described in detail. The first row of terminals 211 includes electrical terminals 208 that can be mechanically and electrically matched with the mating connector and empty terminals 209 that are not mechanically and electrically connected with the mating connector. During production, punch off the mating portion 231 of at least one terminal on at least one of two sides of the first row of terminals 211 to form the empty terminal 209. The first row of terminals 211 is formed by punching out multiple terminals through several cycles and removing at least the last terminal. The number of multiple terminals punched out each time is the same. The ground terminal 204 and the signal terminal have different shapes. Use G to represent the ground terminal 204 and S to represent the signal terminal. In the present invention, the first row of terminals 211 has thirty electrical terminals 208 and four empty terminals 209. The arrangement order of the thirty electrical terminals is GSSGSSGSSGSS in the high-speed terminal area 202, GSSSSG in the sideband terminal area, and SSGSSGSSGSSG in the high-speed terminal area. The first row of terminals 211 is connected by two separate strips or connecting portions 240 before being integrally formed with the corresponding first insulating member 212. The terminals on each connecting portion 240 are formed by removing the last terminal after six punching cycles in the SSG sequence. After six stamping cycles, each strip has eighteen terminals, and the last terminal G on the two connecting parts 240 is removed, so that seventeen terminals are connected to each connecting part 240. After the first insulating member 212 is formed, the mating portions 231 of two terminals on each side of the first row of terminals 211 in the transverse direction are removed to form empty terminals 209. Use three terminals close to each other on each of the strip as sideband terminals 206. The six sideband terminals 206 are arranged in sequence as GSS SSG, the two outermost sideband terminals 206 are not only electrically and mechanically connected to the transfer terminal 207 but also integrally connected to the corresponding connecting portion 240. Compared with stamping the first row of terminals 211 at one time, punching three terminals at each time can improve the dimensional accuracy of the terminals.

The cable 30 is mechanically and electrically connected to the rear of the high-speed terminal area 202. The cable 30 includes a pair of signal core wires 310 that are mechanically and electrically connected to the corresponding pair of signal terminals 205, a shielding layer 320 provided outside the pair of signal core wires 310, and an insulation layer 330 covering the shielding layer 320. The signal core wire pair 310 includes a pair of inner conductors 301 and an inner insulation layer 302 covering each of the inner conductors 301. The pair of inner conductors 301 are soldered to the tail portions 233 of the corresponding signal terminal pairs 205. The tail portion 233 of the ground terminal 204 is integrally connected to the connecting portion 240 and is electrically connected to the shielding layer 320.

The electrical connector assembly 900 further includes a grounding member 40. The grounding member 40 is located on one side of the connecting portion 240 in the vertical direction and is directly mechanically and electrically connected to the connecting portion 240. Each of the high-speed terminal areas 202 has an independent grounding member 40. The grounding member 40 surrounds each of the signal core wire pairs 310 and is mechanically and electrically connected to the corresponding shielding layer 320. The grounding member 40 includes four independently arranged. The grounding member 40 includes shielding areas surrounding the signal core wire pair 310 and connection areas connecting the adjacent shielding areas. The grounding member 40 includes a first part 410 or an upper grounding part and a second part 420 or a lower grounding part that cooperates with the first part 410. Each of the first part 410 and the second part 420 include a plurality of raised portions 401 and a flat portion 402 connecting the adjacent raised portions 401. The raised portions 401 of the first part 410 and the second part 420 jointly form the shielding area. The corresponding flat portion 402 jointly form the connection area. The raised portion 401 covers the corresponding cable 30 and is electrically connected to the shielding layer 320. A plurality of tabs 241 are integrally stamped form the connecting portion 240. The grounding member 40 has a plurality of holes 441 that match the corresponding tabs 241. The hole 441 is provided on the flat portion 402. Each of the tabs 241 passes through the corresponding hole 441 and is soldered to the grounding member 40. The grounding member 40, the shielding layer 320 of the cable 30, the connecting portion 240 and the grounding terminal 204 are electrically connected together to form a common ground, which move the crosstalk to a higher frequency, reduce the crosstalk within the operating frequency, and improve the signal transmission performance of the high-speed terminal module to ensure effective signal transmission.

The electrical connector assembly 900 further includes a mounting member 50 disposed on the transfer terminals 207. The mounting member 50 is convenient for the mounting feet 271 to be pressed and installed on the external circuit board. The mounting member 50 includes a fixing part 501 fixed to the transfer terminal 207, a pressing part 502 extending upward from the fixing part 501, and a retaining part 503 extending from the left and right sides of the fixing part 501. The mounting member 50 is assembled at the rear of the horizontal part 275 and the upper part of the vertical part 273. The mounting member 50 is located on the upper part of the positioning member 260. An external force may be applied to the upper surface 504 of the pressing part 502, and the mounting member 50 can transmit the external force to the positioning member 260 so that the mounting feet 271 of the transfer terminal 207 can be mounted to the external circuit board. The mounting member 50 includes a front mounting member 510 and a rear mounting member 520. The front mounting member 510 includes terminal holes 515 for each of the horizontal portions 275 to pass through, grooves 516 for accommodating the corresponding vertical portions 273 of the front row, and grids 517 spaced apart from the grooves 516. The front surface of the vertical portion 273 of the front row abuts the bottom surface of the groove 516. The front surface of the vertical portion 273 of the rear row abuts the rear surface of the grid 517. The mounting member 50 is located on the rear exterior of the insulative housing 10 to facilitate the application of force.

The electrical connector assembly 900 further includes a metal retainer 60 for fixing the upper terminal module 21 and the lower terminal module 22. The metal retainer 60 is a one-piece structure. The metal retainer 60 includes a bottom wall 610 and two side walls 620 protruding upward from the bottom wall 610. The bottom wall 610 has an opening 611 for all the mounting feet 271 to pass through. The positioning member 260 is received in the opening 611. The front positioning member 261 and the rear positioning member 262 are partially staggered in the transverse direction. The contour shape of the opening 611 matches the cross-sectional shape of the front positioning member 261 and the rear positioning member 262. In other embodiments, the metal retainer 60 can also be replaced with other non-metallic materials.

The electrical connector assembly 900 further includes an upper molding block 710 integrally formed on the cable 30 connected to the upper terminal module 21, and a lower molding block 720 integrally formed on the cable 30 connected to the lower terminal module 22. The rear insulator 250, the mounting member 50, the upper molding block 710 and the lower molding block 720 are all matched with the metal retainer 60. The outer side wall of each rear insulator 250 includes a plurality of bumps 251 and an installation space 252 located between adjacent bumps 251. Each of the side walls 620 of the metal retainer 60 includes a plurality of protruding pieces 621 and spacing spaces 622 between the protruding pieces 621. The protruding piece 621 is inserted into the corresponding installation space 252 and interferes with the bump 251. An installation gap 253 is formed on the insulator 250. The front and rear sides of the protruding piece 621 are held in the installation gap 253. The retaining parts 503 of the front mounting member 510 and the rear mounting member 520 are jointly received in a same spacing space 622 of the metal retainer 60 along the front and rear directions. The upper molding block 710 and the lower molding block 720 are aligned in the up and down direction and are accommodated together in a same spacing space 622.

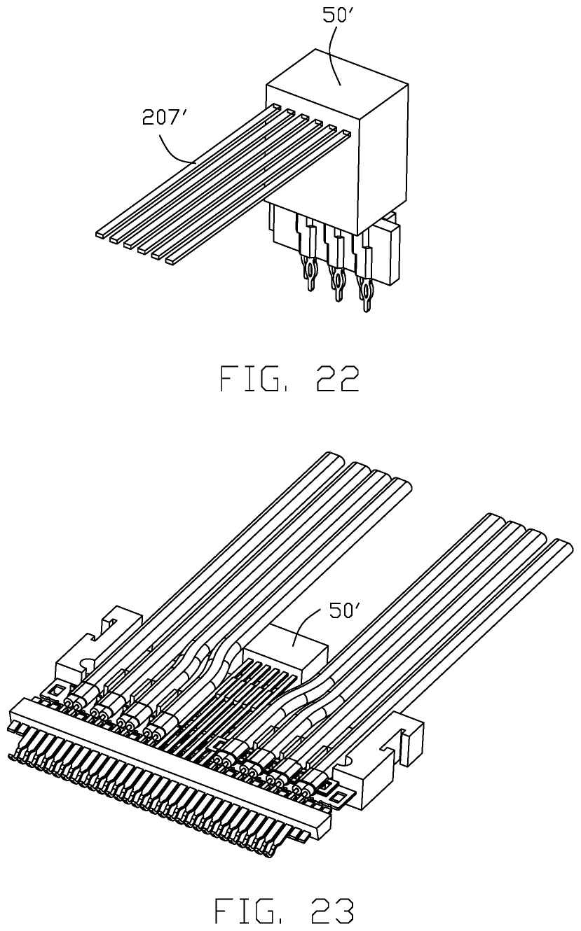

Referring to FIGS. 22-23, a second embodiment of the mounting member 50 of the present invention is shown. Compared with the previous embodiment, in this embodiment, the mounting member 50′ is integrally formed on the transfer terminal 207′.

A method of making the electrical connector assembly 900 comprises: molding insulating material on the first row of terminals 211 to form the first terminal module 210; molding insulating material on the second row of terminals 221 to form the second terminal module 220; mechanically and electrically connecting the cable 30 to the high-speed terminal area 202; and using the same mold and the same method to make the first terminal module 210 and the second terminal module 220.

Another method of making the electrical connector assembly 900 is as follows. A terminal strip is provided and the terminal strip is punched to form a plurality of terminal groups each including a plurality of terminals arranged in the transverse direction, followed by molding insulating material on each of the terminal groups to form a terminal module. Flip one of the terminal modules and stack it with the other terminal module in the up and down direction, and then install it into the insulative housing 10.

The structures of the first terminal module 210 and the second terminal module 220 of the electrical connector assembly 900 are exactly the same, so as to share the mold, reduce the manufacturing cost, and the structure is relatively simple.

The electrical connector assembly 900 of the present invention includes a connecting portion 240 that connects the ground terminals 204 together, and a grounding member 40 that is electrically connected to the connecting portion 240. The grounding member 40 is electrically connected to the corresponding shielding layer 320 of the cable 30 and circumferentially surrounds each of the signal core wire pairs 310, has good anti-interference and grounding effects, improves the transmission performance of the signal terminal, and ensures effective signal transmission.

The electrical connector assembly 900 fixes the upper terminal module 21 and the lower terminal module 22 together through the metal retainer 60, so that the electrical connector assembly 900 has a compact structure and is easy to assemble. The bottom wall of the metal retainer 60 is provided with openings for all mounting feet 271 to pass through, and to position the upper and lower circuit board mounting terminals, resulting in higher assembly accuracy.

The electrical connector assembly 900 of the present invention is provided with a mounting member 50, and external force apply on the mounting member 50 to press and install the mounting feet 271 on the external circuit board.

The electrical connector assembly 900 of the present invention conforms to the specification of OSFP, which defines eight transmitting channels and eight receiving channels, the signal transmission rate of each channel can reach 50 Gbps or above. Of course, the present invention can also be applied to high-speed electrical connector assembly such as SFP-DD, SFP, QSFP-DD, etc.

1. An electrical connector assembly comprising:
an insulative housing having a front mating slot and a rear receiving space;
a terminal module including a first terminal module and a second terminal module stacked with each other in a vertical direction; and
a cable electrically connected to the terminal module; wherein
the first terminal module includes a first row of terminals arranged in a transverse direction perpendicular to the vertical direction and a first insulating member holding the first row of terminals, the second terminal module includes a second row of terminals arranged along the transverse direction and a second insulating member holding the second row of terminals, each of the first row of terminals and the second row of terminals include a sideband terminal area and high-speed terminal areas located on two sides of the sideband terminal area in the transverse direction, the cable is mechanically and electrically connected to the high-speed terminal area, the sideband terminal area includes a plurality of sideband terminals, and the first row of terminals and the second row of terminals have same structure.

2. The electrical connector assembly as claimed in claim 1, further including a transfer terminal for mounting on an external circuit board.

3. The electrical connector assembly as claimed in claim 1, wherein each of the first row of terminals and the second row of terminals include a plurality of electrical terminals for mating with a mating connector, and at least one empty terminal space is provided on at least one of the two sides of the electrical terminals in the transverse direction.

4. The electrical connector assembly as claimed in claim 1, wherein the terminals in the high-speed terminal area include a plurality of ground terminals and signal terminal pairs arranged between adjacent ground terminals, each of the ground terminal and the signal terminal includes a mating portion and a tail portion, and the cable includes a pair of signal core wires connected to a corresponding pair of signal terminals and a shielding layer outside each pair of signal core wires.

5. The electrical connector assembly as claimed in claim 4, further including a connecting portion that connects at least two ground terminals together and a grounding member that circumferentially surrounds each pair of signal core wires and is electrically connected to a corresponding shielding layer.

6. The electrical connector assembly as claimed in claim 5, wherein the grounding member is arranged on the connecting portion and is mechanically and electrically connected to the connecting portion.

7. The electrical connector assembly as claimed in claim 6, wherein the connecting portion is connected to at least three ground terminals, the connecting portion is provided with a plurality of tabs, and the grounding member has a number of holes mechanically and electrically connected to corresponding tabs.

8. The electrical connector assembly as claimed in claim 7, wherein the grounding member includes an upper grounding part and a lower grounding part that cooperate with each other, each of the upper grounding part and the lower grounding part including at least two raised portions covering the cable, and a flat portion connected to adjacent raised portions, the raised portion is electrically connected to the shielding layer, and the holes are provided on the flat part.

9. The electrical connector assembly as claimed in claim 7, wherein the transfer terminal has plural mounting feet for mounting on an external circuit board.

10. The electrical connector assembly as claimed in claim 9, further including a metal retainer for fixing the first terminal module and the second terminal module, and wherein the metal retainer includes a bottom wall and two side walls protruding upward from the bottom wall, and the bottom wall has openings for all of the mounting feet to pass through.

11. The electrical connector assembly as claimed in claim 10, further including a mounting member for pressing the mounting feet of the transfer terminal to the external circuit board.

12. The electrical connector assembly as claimed in claim 11, wherein the mounting member includes a fixing part fixed to the transfer terminal and a pressing part extending upward from the fixing part.

13. The electrical connector assembly as claimed in claim 11, wherein the mounting member is located on a rear exterior of the insulative housing.

14. A method of making an electrical connector assembly, comprising the steps of:
molding an insulating material on a first row of terminals to form a first terminal module;
molding an insulating material on a second row of terminals to form a second terminal module, wherein each of the first row of terminals and the second row of terminals include a sideband terminal area and two high-speed terminal areas located on two sides of the sideband terminal area in a transverse direction; and
connecting the cable to the high speed terminal area, wherein the first row of terminals and the second row of terminals are manufactured using same mold and by same method.

15. The method as claimed in claim 14, wherein the sideband terminal area includes a plurality of sideband terminals, and one end of a transfer terminal is connected to a corresponding sideband terminal.

16. The method as claimed in claim 15, wherein the first row of terminals are formed by removing a last terminal after several cycles of stamping multiple terminals.

17. The method as claimed in claim 16, wherein the number of multiple terminals punched out each time is the same.

18. The method as claimed in claim 14, wherein at least one terminal on at least one of the two sides of the first row of terminals and the second row of terminals is punched off so as not to form a mechanical and electrical connection with a mating connector.

19. A method of making an electrical connector assembly, comprising the steps of:
stamping a metal strip to form a plurality of terminal groups each including a plurality of transversely arranged terminals;
molding insulating material on each of the terminal groups to form a terminal module;
turning one of the terminal modules over to be stacked up and down with another terminal module; and
installing the stacked terminal modules into an insulative housing.

20. The method as claimed in claim 19, wherein each terminal group is formed after several cycles of punching out multiple terminals and then removing the last terminal.
